(19) United States
(12) Patent Application Publication
(10) Pub. No.: US 2010/0196718 A1
(43) Pub. Date: Aug. 5, 2010

(54) COATED MEDICAL DEVICES WITH ADHESION PROMOTERS

(75) Inventors: George Leslie Oltean, Rochester, NY (US); Mildred Calistri-Yeh, Florham Park, NJ (US); Donald Michael Copenhagen, Bloomfield, NY (US)

Correspondence Address: ANGIOTECH, P.O. BOX 2840, NORTH BEND, WA, 98045, US

(73) Assignee: ANGIOTECH BIOCOATINGS CORP., Henrietta, NY (US)

(21) Appl. No.: 12/520,814

(22) PCT Filed: Dec. 18, 2007
(86) PCT No.: PCT/US07/25790

§ 371 Date: Apr. 5, 2010

Related U.S. Application Data
(60) Provisional application No. 60/871,663, filed on Dec. 22, 2006.

(51) Int. Cl. B32B 9/04; B05D 3/10

(52) U.S. Cl. 428/411.1; 427/2.1

(57) ABSTRACT

A medical device includes a polymer composition on a surface. The polymer composition is bonded to a surface of the medical device using an adhesion promoter.

This application claims priority under 35 U.S.C. §119(e) to U.S. Patent Application Ser. No. 60/871,663 filed on 22 Dec. 2006, which is hereby incorporated by reference in its entirety.

### TECHNICAL FIELD

The present invention relates to coated medical devices.

### BACKGROUND

Medical devices can be coated with a variety of different compositions for a variety of purposes. For example, a medical device can be coated with a composition that includes a pharmaceutical component to assist with healing or provide treatment to a target tissue. In other examples, the medical device can be coated with a composition that can assist with imaging the device, or a composition that otherwise enhances its use, such as a lubricious coating. Having good adhesion of the coating to the device is important for device performance and reliability.

### SUMMARY

Medical devices can be coated with a composition, for example, a polymer coating including a hydrophilic component, a lubricant, an echogenic material, a radio-opaque component, or a pharmaceutical component. Adhesion of the coating to a surface of the device can be improved or otherwise enhanced by applying an adhesion promoter to a surface of the device. The adhesion promoter can be applied to the surface prior to applying the composition to the surface. Alternatively, or in combination, the adhesion promoter can be included in the composition being applied to the surface.

In one aspect, a process for producing a medical device includes applying an adhesion promoting composition to a portion of a surface of a medical device, applying a polymer composition to a portion of the surface of the device, and applying a biopolymer composition to a portion of the surface of the device. The surface of the device includes a plurality of surface functional groups, and the adhesion promoting composition includes an adhesion promoter. The adhesion promoter includes a promoter functional group capable of reacting with the surface functional groups. The adhesion promoting composition is applied under conditions selected to cause reaction between the promoter functional groups and the surface functional groups. The adhesion promoter retains a plurality of unreacted promoter functional groups after reaction with the surface functional groups. The polymer composition includes a plurality of polymer functional groups capable of reacting with promoter functional groups. The polymer composition is applied under conditions selected to cause reaction between the promoter functional groups and the polymer functional groups, wherein the biopolymer composition comprises a therapeutic or diagnostic agent.

In another aspect, a process for producing a medical device includes applying an adhesion promoting composition to a portion of a surface of a medical device, and applying a biopolymer composition to a portion of the surface of the device. The biopolymer composition can be applied to the same portion of the surface as the adhesion promoting composition, for example, over the adhesion promoting composition. The biopolymer composition includes a therapeutic or diagnostic agent. The surface of the device includes a plurality of surface functional groups, and the adhesion promoting composition includes an adhesion promoter. The adhesion promoter includes a promoter functional group capable of reacting with the surface functional groups. The adhesion promoting composition is applied under conditions selected to cause reaction between the promoter functional groups and the surface functional groups. The adhesion promoter retains a plurality of unreacted promoter functional groups after reaction with the surface functional groups.

In another aspect, a medical device includes a coating on a portion of a surface of the device. The coating includes a polymer composition and a linking group forming a covalent bond between the surface of the device and a component of the polymer composition. The covalent bond includes a metal ether linkage.

The reaction between the promoter functional groups and the surface functional groups can form a plurality of covalent bonds between the adhesion promoter and the surface of the device. Promoter functional groups that do not react with the surface functional groups may react with polymer functional groups. The reaction between the promoter functional groups and the polymer functional groups can form a plurality of covalent bonds between the adhesion promoter and the polymer composition.

The process can include treating the surface of the device with an ionizing treatment. Treating with an ionizing treatment can include exposing the surface to a plasma.

In some embodiments, the surface of the device can include a metal, a plastic such as polyethyleneterephthalate, a polyimide, a polyolefin, a nylon, a polyurethane, an epoxy, a phenolic, a fluorinated polymer, a polyacrylate, a polymethacrylate, or a silicone or polysiloxane. The device can include a polymer substrate, such as a silicone, a polyimide, a PTFE, a polyethylene, or a polyester. The device can include a metal substrate, such as titanium, stainless steel, nickel, gold, chrome, nickel, tantalum, nitinol, platinum, silver, cobalt, an alloy including titanium, an alloy including stainless steel, an alloy including nickel, an alloy including gold, an alloy including chrome, an alloy including tantalum, an alloy including platinum, an alloy including silver, or an alloy including cobalt.

The adhesion promoter can include an organic titanate, an organic zirconate, or an organic silane.

The biopolymer composition can include a lubricious component, a medication component, a colored component, an abrasion-resistant component, an ultrasonically opaque component, a radio-opaque component, a MRI-compatible component, or an endothelialization component.

The metal ether linkage can be a titanium ether linkage, a zirconium ether linkage, or a silicon ether linkage.

Other features, objects, and advantages of the invention will be apparent from the description and drawings, and from the claims.

### DESCRIPTION OF DRAWINGS

FIG. 1 is a schematic diagram of a device having a coating and an adhesion promoter between the device and the coating.

### DETAILED DESCRIPTION

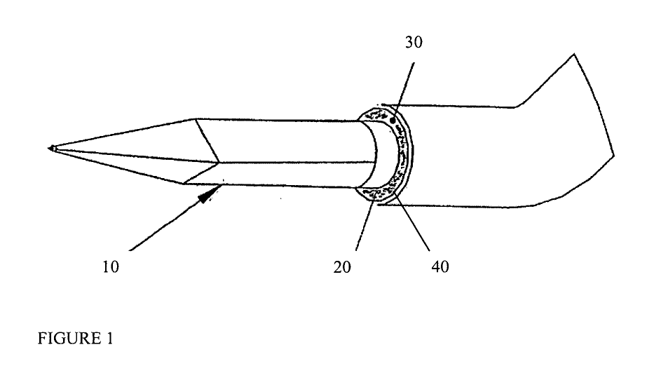

A medical device can have a coating on an external surface. The coating can be abrasion resistant, lubricious, and biocompatible. Referring to FIG. 1, a device 10 can include an adhesion promoter 20 between a surface of the device 10 and a polymer layer 30. A second polymer layer 40 can be positioned on a surface of layer 30. For example, a medical device can include a coating on a portion of a surface the device. The coating can include a polymer composition. The coating can also include a linking group which forms a covalent bond between the surface of the device and a component of the polymer composition. Optionally, one or more intermediate layers are present between the surface of the device and the external layer. Each coating can be thin, for example, between 0.1 and 0.0001 inches, or between 0.1 and 0.001 inches.

A process for producing a medical device includes applying an adhesion promoting composition to a portion of a surface of a medical device. The surface of the device includes a plurality of surface functional groups. The adhesion promoting composition includes an adhesion promoter which includes a promoter functional group capable of reacting with the surface functional groups. The adhesion promoting composition is applied under conditions selected to cause reaction between the promoter functional groups and the surface functional groups. The adhesion promoter retains a plurality of unreacted promoter functional groups after reaction with the surface functional groups. A polymer composition can be applied to a portion of the surface of the device, for example, the same portion of the surface of the device. The polymer composition includes a plurality of polymer functional groups capable of reacting with promoter functional groups. The polymer composition is applied under conditions selected to cause reaction between the promoter functional groups and the polymer functional groups. In certain circumstances, a second polymer composition can be applied to the first composition.

The linking group or promoter functional group is a chemical moiety capable of forming a covalent bond with a functional group on a surface of the device, the surface functional group. The surface of the device can be a metal, a plastic such as polyethyleneterephthalate, a polyimide, a polyolefin, a nylon, a polyurethane, an epoxy, a phenolic, a fluorinated polymer, a polyacrylate, a polymethacrylate, or a silicone or polysiloxane. The surface functional group can be a hydroxyl group, an amino group, a carboxyl group, an amide group, or a thio group. For example, the linking group or promoter functional group can be an isocyanate, an activated ester, such as an N-hydroxy succinimide ester, an acid chloride, or a metal salt. The metal salt can be a titanate, zirconate, silane, borate, an aluminate, a magnesium salt, a phosphate, a germanate, an indium salt, or a stannate. The metal salt can be an alkoxide, a halide, carbonate, carboxylate, or a sulfonate salt. In certain examples, the metal salt can include a metal alkoxide, such as a titanium alkoxide, a silicon alkoxide, or a zirconium alkoxide. Other ligands can be added to the metal salt, for example, a chelating ligand, such as 2,2′-bipyridine (bipy), ethylenediamine (en), diphenylphosphinoethane (dppe), acetylacetonate (acac), ethylacetoacetate, an alkanolamine, or oxalate (ox). The metal salt can be dissolved or suspended in an organic solvent and subsequently applied to the surface of the device. Suitable organic solvents can be capable of mixing with water and are substantially unreactive toward the metal salt, for example, ethyl acetate, ethers (e.g., tetrahydrofuran and dioxane), C1-6 alkanol (e.g., methanol, ethanol, 1-propanol, and 2-propanol), alkoxyalcohols (e.g., 2-ethoxyethanol-2-(2-methoxyethoxy)ethanol, 2-methoxyethanol, 2-(2-ethoxymethoxy)ethanol, and 1-methoxy-2-propanol), ketones (e.g., acetone, methyl ethyl ketone, and methyl isobutyl ketones, or mixtures of any of these compounds.

In general, the linking agent is an adhesion promoter. The conditions of application, for example, heating or exposing the surface to moisture, are selected to form a covalent bond between the surface functional group and the promoter functional group. By forming a covalent bond with the surface of the device, the linking agent improves the adhesion of a second composition subsequently applied to the surface. The metal salt can react with a functional group on a surface of the device to form a metal ether linkage (-M-O—). The metal salt can also react with other components of the mixture such as water to form a thin layer of a metal oxide matrix at the surface of the device. The metal oxide matrix can include a titanium oxide, an aluminum oxide, a silicon oxide, a magnesium oxide, a boron oxide, a phosphorus oxide, a germanium oxide, an indium oxide, a tin oxide, a zirconium oxide, or mixtures thereof. The linking agent also reacts with other functional groups within a composition applied to the surface, for example, amino, hydroxyl, and thiol groups of a polymer or other component applied to the surface. Examples of suitable adhesion promoters include titanium, zirconium or silicon alkoxides, for example, TYZOR organic titanates available from DuPont, including tetraethyltitanate, tetraisopropyltitanate, tetra-n-propyltitanate, tetra-n-butyl titanate, n-butyltitanate polymer, tetra-2-ethylhexyltitantate, octyleneglycoltitanate, titanium acetylacetonate, titanium ethylacetoacetate, triethanolamine titanate, alkoxy zirconate, or complex amine zirconate (TYZOR ET, TPT, NPT, TnBT, BTP, TOT, OGT, AA, AA-65, AA-75, AA-105, GBA, DC, TE, NPZ, NBZ, or 212).

For example, a titanate can react with functional groups at a surface of the device (e.g., surface hydroxy groups) and to functional groups in a composition applied to the surface to form the covalent bond through a sol-gel type of reaction. Thermal annealing can help strengthen the bond formed between the components. See, for example, “Silicon Compounds: Register and Review,” 5^{th} edition, edited by R. Anderson, G. L. Larson, and C. Smith, Huls America, 1991, which is incorporated by reference in its entirety.

The device can be, for example, knives (e.g., ophthalmic blades), scalpels, rongeurs, dissectors, scissors, needle drivers, suture holders, curettes, electrodes, probes, forceps, aneurysm clip applicators, or other items used in medical applications. The coating can be employed to reduce the coefficient of friction of instruments including, for example, a lubricious coating. The coatings can enhance the ultrasound visibility of surfaces of needles, catheters, and laparoscopic devices, such as intravascular retrieval snares or baskets. A portion of, or the entire surface of, the medical device may be provided with a coating. In some cases, a portion of the instrument (such as, for example, a handle) is uncoated so that the uncoated portion provides a higher friction surface than a coated portion.

The polymer composition can be a primer layer or a biopolymer composition. The biopolymer composition can be a composition suitable for contacting biological tissues and/or patients. In certain circumstances, the biopolymer composition can include a pharmaceutical component, such as a therapeutic or diagnostic agent. The biopolymer composition can be a medication component, such as a pharmaceutical or other therapeutic, a colored component, such as a dye, an abrasion-resistant component, an ultrasonically opaque component, a radio-opaque component, an MRI-compatible component, such as an MRI image contrast agent, or an endothelialization component, or a combination thereof.

The polymer composition can be a primer coating (for example, BOND-COAT®), as described in U.S. Pat. Nos. 5,997,517, 6,306,176, and 6,110,483 each of which is incorporated by reference in its entirety. In certain circumstances, the polymer composition can include an echogenic component, for example, an echogenic coating (for example, ECHO—COAT®), as described in U.S. Pat. Nos. 6,106,473 and 6,610,016, and U.S. Patent Publication No. 2004/0077948, each of which is incorporated by reference in its entirety. In certain circumstances, the polymer composition can include a lubricious component, for example, a lubricious coating (for example, SLIP-COAT®), as described in U.S. Pat. Nos. 5,001,009 and 5,331,027, each of which is incorporated by reference in its entirety. In certain circumstances, the composition can include a dye component to make the device optically visible during surgical procedures.

In general, a material can be applied to a surface of the medical device using a number of different techniques. For example, the coating material can be dissolved in a solvent, the resulting solution contacted to the device, and the solvent removed. The coating can be applied using standard coating methods, such as by spraying, dipping, roll coating, bar coating, spin coating, or wiping, or may be manufactured using an extrusion process. Certain characteristics of the coating (e.g., thickness) can be varied by adjusting the amount of time (i.e., dwell time) that the device remains in contact with the coating solution and the speed at which the device passes through the coating solution. The coating can be applied as a solution, and then the solvent can be allowed to evaporate. Evaporation can be promoted by an elevated temperature. The solution for depositing the external layer can include a solvent that is capable of solubilizing (at least partially) components of the composition.

Examples of solvents useful for applying the coatings to a device can include butyrolactone, alcohols (e.g., methanol, ethanol, isopropanol, n-butyl alcohol, i-butyl alcohol, t-butyl alcohol, and the like), dimethyl acetamide, and n-methyl-2-pyrrolidone. These solvents and others cause different degrees of swelling of a plastic substrate or inner layer, as the case may be. The duration and temperature of solvent evaporation may be selected to achieve stability of the coating layer and to achieve a bond between the surface being coated and the coating layer. It is possible to control the degree of stability, wet lubricity, insolubility, flexibility, and adhesion of the coating by varying the weight-to-volume percentages of the components in the coating solutions. The coating can be dried, typically at temperatures between 50° C. and 120° C., but may be done at higher or lower temperatures.

In some cases, kits can include a medical device, coated or uncoated and are provided with a swab, which can be wetted with a coating material for coating the surface of the instrument. The kit can be useful in circumstances where it is desirable to apply the coating to the device a short time before the device is used in a medical procedure.

When the coating includes more than one layer (i.e., at least one intermediate layer in addition to the external layer), the layers can be sequentially applied to the device to form the coating. For example, if the coating includes one intermediate layer and an external layer, the intermediate layer can be applied to the device and dried. The external layer is then subsequently applied. An intermediate layer can be a bonding layer selected to promote adhesion of the external layer to the device. The bonding layer can promote abrasion resistance of the outer layer, and prolong adhesion of the outer layer to the after soaking in water, when compared to a coating without the bond coat layer. The coating can remain adhered to the device when subjected to bending through a small radius. Depending on the substrate material, an additional primer (pre-coat) layer may be used to further improve the adhesion of the bonding and/or lubricious coating layers to the substrate.

The polymer composition can include a hydrophilic polymer. The hydrophilic polymer can include a polyethylene copolymer, for example poly(ethylene-co-acrylic acid) having 5-30 wt % acrylic acid content, a polyacrylate, an epoxy resin, a polyurethane, a melamine-formaldeyde resin, a poly(vinylpyrrolidone) (PVP) or a PVP-vinylacetate copolymer. The hydrophilic polymer of the external layer can have a molecular weight of, for example, greater than 100,000, greater than 150,000, greater than 200,000, greater than 250,000, greater than 300,000, greater than 350,000, or greater than 400,000. In some cases, the hydrophilic polymer of the external layer has a molecular weight in the range of 120,000-360,000. PVP of lower molecular weight, as low as 15,000, can be used in an underlayer or base coating next to the substrate without deterioration of performance. Some or all of the PVP can be replaced with PVP-vinylacetate copolymer.

Suitable epoxy resins include diglycidyl ethers of bisphenol A, and diglycidyl ether of dipropylene glycol and others, for example, resins available from The Dow Chemical Company as D.E.R.™ 383, D.E.R.™ 664, D.E.R.™ 736, D.E.R.™ 667, D.E.R.™ 669E, D.E.R.™ 661, D.E.R.™ 664, or D.E.R.™ 664, and available from Reichhold Inc. as EPOTUF 37-601, EPOTUF 37-100, EPOTUF 37-127, EPOTUF 37-140, EPOTUF 37-143, EPOTUF 37-151, EPOTUF 37-618, EPOTUF 37-620, EPOTUF 37-625, EPOTUF 37-630, EPOTUF 37-640, EPOTUF 37-650, EPOTUF 37-680, EPOTUF 37-685, EPOTUF 37-703, EPOTUF 38-406, EPOTUF 38-505, EPOTUF 38-515, EPOTUF 38-692, EPOTUF 38-694, EPOTUF 404-XX-60, EPOTUF 607, EPOTUF 91-263, EPOTUF D808-XD-71, and EPOTUF® 38-411. Suitable polyurethanes include an aliphatic polyurethane, such as an aliphatic polyether-based polyurethane, or an aromatic polyurethane, for example, polyurethanes available from CT Biomaterials as CHRONOFLEX AL, CHRONOFLEX AR and CHRONOFLEX C, and available from Thermedics Polymer Products as TECOFLEX TPU, TECOTHANE TPU, CARBOTHANE® TPU, TECOPHILIC® TPU, TECOPLAST® TPU, TECOFLEX SG-80A, TECOFLEX SP-80A-150, TECOFLEX SG-85A, TECOFLEX SP-93A-100, TECOFLEX SG-93A, TECOFLEX SP-60D-60 and TECOFLEX SG-60D. Suitable polyacrylates include vinyl acetate acrylic copolymers and blends, including polyacrylates available from Rohm and Haas as MEGUM and THIXON. Suitable melamine-formaldehyde resins are available, for example, from American Cyanamid as AEROTEX, for example, AEROTEX 3730, and Dynea, as MF Resins.

The polymer composition can include a stabilizing polymer, which can help stabilize components within the composition from decomposition or deactivaction during, for example, handling, sterilization, shelf storage, and exposure during the indwelling period of the device in a patient. For example, the stabilizing polymer can be a water-insoluble cellulose polymer (e.g., nitrocellulose), polymethylvinylether/maleic anhydride, or nylon, or a combination thereof. In some cases, a water-insoluble cellulose polymer is preferable as a stabilizing polymer, for ease of handling and for tendency to produce coatings with greater long-term wet abrasion resistance than coatings prepared with other stabilizing polymers. When the stabilizing polymer is nitrocellulose, a plasticizing agent can be used in conjunction with the nitrocellulose. Suitable nitrocellulose is available from Penn Color as RS Nitrocellulose, and Filo Chemical as Hagedorn H-4, Hagedorn H-7, Hagedorn H-9, Hagedorn H-12, Hagedorn H-15, Hagedorn H-22.5, Hagedorn H-24, Hagedorn H-27, Hagedorn H-28, and Hagedorn H-30, or from Bergerac as Bergerac e15, Bergerac e19, Bergerac e24, Bergerac e27, Bergerac e33, Bergerac e60, Bergerac e80, and Bergerac e90.

The polymer composition can additionally include materials such as other polymers, plasticizers, reactive agents such as anti-infective materials, colorants such as dyes and pigments, stabilizers, plasticizers, or fillers. The additional components can be present in amounts ranging from 0.01% to 70% weight %. In addition, the coating compositions may contain crosslinking agents, in amount ranging from 0.01% to 30% weight %. The coating can contain dyes, stains, or pigments or salts useful in diagnosis, such as, for example, Gentian violet, indocyanine green, methylene blue, cresyl blue, VisionBlue or trypan blue.

An exemplary solution for applying a polymer composition to a surface can include PVP in a range from 0.01% to 30% w/w of the coating solution polymer component, preferably from 0.5 to 20% w/w, and more preferably 1% to 8% w/w. The amount of stabilizer polymer can range from 0.01% to 20% w/w, preferably from 0.05% to 10% w/w, and more preferably 0.01 to 5% w/w. Commercial sources of the polyvinylpyrrolidone include International Speciality Products (ISP) and BASF. Ratios of polyvinylpyrrolidone to stabilizing polymer can range from 0.04/99.96 to 99.97/0.03 w/w in the coating solutions. In polymer compositions, the amount of polyurethane or polycarbonate-based polyurethane can range from 0.05% to 40% w/w, preferably from 0.1% to 20%, and most preferably 3% to 12%. The amount of stabilizer polymer can range from 0.1% to 10%, preferably from 0.5% to 7%, and most preferably 1% to 5%. Polyvinylpyrrolodone is available from BASF and ISP in various molecular weight grades. Commercial sources of the polyurethane and polycarbonate-based polyurethane include Cardiotech International and Thermedics, Inc. Commercial sources of the stabilizer include Hagedorn Akteingesellschaft Chemical, I.C.I., Nobel Enterprises, and Bergerac. Cellulose nitrates are available in various viscosity and nitration grades from Hagedorn Akteingesellschaft.

The solution which forms the external layer can be applied to a deposited coating formed from a mixture of polyurethane or polycarbonate-based polyurethane and stabilizer such as cellulose nitrates.

In some cases, a primer layer may be applied directly to the surface of the medical device after the surface has been treated with the adhesion promoter. Alternatively the primer layer can include the adhesion promoter in the composition. Either the solution which forms the external layer or an intermediate layer can be applied to the primer. In a solution for applying a primer layer, the amount of primer polymer may range from 0.5% to 6% w/v, preferably from 1% to 4% w/v, and most preferably 1.5% to 3% w/v. The amount of stabilizer polymer can range from 0% to 10% w/v, preferably from 0.2% to 6% w/v, and most preferably 0.3% to 3% w/v. See, for example, U.S. Pat. No. 6,306,176, which is incorporated by reference in its entirety.

An adhesion promoter, for example, a metal alkoxide, can be used to improve adhesion of a polymer composition to a surface of a medical device. For example, an organic titanate can improve adhesion to a surface of a silicone-based device. In another example, addition of organic titanate can improve adhesion of a polymer composition to a base-coat layer. In another example, use of an adhesion promoter can allow epoxy resin to be avoided to provide good adhesion to silicone or metal. In another example, plasma treatments (such as, e.g., oxygen, ammonia, or nitrogen plasmas) can further improve adhesion to silicone when used in combination with organic titanate primer layers.

The surface of the device can be activated or otherwise treated prior to contact with the adhesion promoter. The surface can be activated or treated, for example, by exposing the surface to moisture, plasma (e.g., oxygen or ammonia plasma), reactive gases, heating, or combinations thereof.

A pharmaceutical agent can be added to a layer that is undergoing adhesion-promoting reactions, such as a coating including an adhesion promoter. In some circumstances, a pharmaceutical agent can be added to a composition that is applied to a second polymer layer applied to a first polymer layer, which can reduce the likelihood of the pharmaceutical agent being chemically altered by reacting with the adhesion promoter, thereby changing its pharmaceutical properties. In certain examples, a tie layer or base-coat layer can be applied to the adhesion promoter to help bind a biopolymer composition, which can include a pharmaceutical or drug containing layer. In other circumstances, the biopolymer composition can include a lubricious layer.

Examples of layers formed with an adhesion promoter are described below. Examples demonstrating multi-layer adhesion were also performed. A variety of primer layers, including an adhesion promoter such as an organic titanate and different surface treatments, such as exposure to plasma were used to achieve good adhesion various combinations of a pre-coat, a base-coat, a biopolymer coating, or a top-coat layer to a device, such as a silicone device. In some examples, a pharmaceutical agent was not included in the adhesion-screening experiments, but in other examples, a pharmaceutical agent was added in a drug-containing layer.

Adhesion testing was performed as follows:

Wet Abrasion Test: This testing was done by folding a piece of brown paper towel into fourths and completely immersing it in water until water is dripping from the paper towel. Next the water soaked paper towel was lightly rubbed over the coated substrate for 50 cycles. One cycle equals a forward stroke of between 6 to 10 cm and a return stroke. If dyed coating was not removed from the substrate or loosened the sample passed. If coating was removed or loosened the sample failed.

Wet Peel Test: This testing was done by cutting through the coating that is on the substrate with a sharp razor. The samples were then immersed in tap water for a short period of time. The samples were removed from the water, while still wet, the thumb or index finger was vigorously rubbed over the cut area for 50 cycles. The sample passed if no dyed coating was peeled from the cut area. The sample failed if coating was loosened or peeled away from the cut area.

Dry Tape Test: This testing was done by cutting through the coating that is on the substrate with a sharp razor. Next a 3 to 5 cm section of cut area is covered using 810 Scotch brand tape. The tape was firmly pressed onto the cut area. The tape was then briskly pulled off the cut area at an 180° angle to the coated substrate. The tape was examined for evidence of dyed coating removal. If no coating is removed, the sample passed. If coating was found on the tape the sample failed the test.

Twist and Pull Test: This test was preformed by first twisting the coated substrate 360° and then elongating the twisted area by 100%, then releasing it. If there was no evidence of coating delamination the sample passed the test.

Twist and Pull Tape Test: This test was preformed by first twisting the coated substrate 360° C. and then elongating the twisted area by 100%, then releasing it. The dry tape test is then preformed on the twisted elongated area using the same pass/fail criteria. The adhesive forces required to pass an adhesion test increases from wet abrasion to wet peel to dry tape to twist and pull to tape twist and pull.

### Control Example 1

Silastic silicone tubing made by Dow Corning was cleaned by immersion in isopropyl alcohol (isopropanol) and wiping of the outside of the tubing with isopropanol. The tubing was allowed to air dry at room temperature overnight. A pre-coat solution composed of the following weight percents (wt. %) was made, 78.43% tetrahydrofuran (THF), 16.30% cyclohexanone, 4.07% poly(ethylene-co-acrylic acid) with 20 wt % acrylic acid content, and 1.20% epoxy resin solution. The pre-coated solution was dip coated onto the silastic tubing and oven dried at 100° C. for 30 minutes. The coated tubing was immersed in a Gentian Violet solution (Ricca Chemical) for 60 seconds after which the excess dye was rinsed off in cold tap water. The dyed samples were allowed to dry before adhesion testing.

### Example 2

Silastic silicone tubing was cleaned by immersion in isopropanol and wiping of the outside of the tubing with isopropanol. The tubing was allowed to air dry at room temperature overnight. An organic titanate primer solution composed of the following wt. % was made, 5% TYZOR GBA a titanium acetylacetonate made by DuPont, 47.5% isopropanol and 47.5% THF. A pre-coat solution composed of the following weight percents was made. 78.43% THF, 16.30% cyclohexanone, 4.07% poly (ethylene-co-acrylic acid) with 20 wt % acrylic acid content, and 1.20% epoxy resin solution. The primer solution was dip coated onto the silastic tubing and allowed to air dry at room temperature for 2 hours. The pre-coated solution was then dip coated over the primer layer and oven dried at 100° C. for 30 minutes. The coated tubing was immersed in a Gentian Violet solution, Ricca Chemical, for 60 seconds after which the excess dye was rinsed off in cold tap water. The dyed samples were allowed to dry before adhesion testing.

Adhesion test results are summarized in Table 1.

TABLE 1

| | Adhesion Test | | | | |
|---|---|---|---|---|---|
| | Wet | Wet | Dry | | Tape |
| | Abrasion | Peel | Tape | Twist & Pull | Twist & Pull |
| Example 1 | Pass | Fail | Fail | Fail | Fail |
| Example 2 | Pass | Pass | Pass | Pass | Fail |

The adhesion tests demonstrate that an organic titanate layer primer layer improved the adhesion of the pre-coat layer to the silicone tubing.

### Control Example 3

Silastic silicone tubing was cleaned by immersion in isopropanol and wiping of the outside of the tubing with isopropanol. The tubing was allowed to air dry at room temperature overnight. A base-coat solution was made with the following wt % composition: 23.3% aromatic polyurethane, 17.47% anisole, and 59.23% methyl isobutyl ketone (MIBK). The base-coat solution was dip coated onto the silastic tubing and oven dried at 100° C. for 30 minutes. The coated tubing was immersed in a Gentian Violet solution, Ricca Chemical, for 60 seconds after which the excess dye was rinsed off in cold tap water. The dyed samples were allowed to dry before adhesion testing.

### Example 4

Silastic silicone tubing was cleaned by immersion in isopropanol and wiping of the outside of the tubing with isopropanol. The tubing was allowed to air dry at room temperature overnight. A base-coat solution was made with the following wt % composition. 23.3% aromatic polyurethane, 17.47% anisole, and 59.23% methyl isobutyl ketone (MIBK). To 10 grams of this base-coat solution was added 0.5 grams of TYZOR TnBT (a tetra n-butyl titanate) made by DuPont. The organic titanate containing base-coat solution was dip coated onto the silastic tubing and oven dried at 100° C. for 30 minutes. The coated tubing was immersed in a Gentian Violet solution, Ricca Chemical, for 60 seconds after which the excess dye was rinsed off in cold tap water. The dyed samples were allowed to dry before adhesion testing.

Adhesion test results are summarized in Table 2.

TABLE 2

| | Adhesion Test | | | | |
|---|---|---|---|---|---|
| | Wet | Wet | Dry | | Tape |
| | Abrasion | Peel | Tape | Twist & Pull | Twist & Pull |
| Example 3 | Pass | Fail | Fail | Fail | Fail |
| Example 4 | Pass | Pass | Pass | Pass | Pass |

The organic titanate incorporated into the base-coat layer improved the adhesion of the base-coat layer to the silicone tubing.

### Example 5

Silastic silicone tubing was cleaned by immersion in isopropanol and wiping of the outside of the tubing with isopropanol. The tubing was allowed to air dry at room temperature overnight. An organic titanate primer solution composed of the following wt. % was made: 5% TYZOR OGT an octyleneglycol titanate made by DuPont, 10.0% isopropanol and 85.0% THF. A pre-coat solution composed of the following weight percents was made: 78.43% THF, 16.30% cyclohexanone, 4.07% poly (ethylene-co-acrylic acid) with 20 wt. % acrylic acid content, and 1.20% epoxy resin solution. The primer solution was dip coated onto the silastic tubing and allowed to air dry at room temperature for 2 hours. The pre-coated solution was then dip coated over the primer layer and oven dried at 100° C. for 30 minutes. The coated tubing was immersed in a Gentian Violet solution, Ricca Chemical, for 60 seconds after which the excess dye was rinsed off in cold tap water. The dyed samples were allowed to dry before adhesion testing.

### Control Example 6

Silastic silicone tubing was cleaned by immersion in isopropanol and wiping of the outside of the tubing with isopropanol. The tubing was allowed to air dry at room temperature overnight. A pre-coat solution composed of the following weight percents was made: 80.0% THF, 16.0% cyclohexanone, 4.0% poly (ethylene-co-acrylic acid) with 20 wt. % acrylic acid content, and no epoxy resin solution. The primer solution was dip coated onto the silastic tubing and allowed to air dry at room temperature for 2 hours. The pre-coated solution was then dip coated over the primer layer and oven dried at 100° C. for 30 minutes. The coated tubing was immersed in a Gentian Violet solution, Ricca Chemical, for 60 seconds after which the excess dye was rinsed off in cold tap water. The dyed samples were allowed to dry before adhesion testing.

### Example 7

Silastic silicone tubing was cleaned by immersion in isopropanol and wiping of the outside of the tubing with isopropanol. The tubing was allowed to air dry at room temperature overnight. An organic titanate primer solution composed of the following wt. % was made: 5% TYZOR OGT an octyleneglycol titanate made by DuPont, 47.5% hexanes and 47.5% THF. A pre-coat solution composed of the following weight percents was made. 80.0% THF, 16.0% cyclohexanone, 4.0% poly (ethylene-co-acrylic acid) with 20 wt. % acrylic acid content, and no epoxy resin solution. The primer solution was dip coated onto the silastic tubing and allowed to air dry at room temperature for 2 hours. The pre-coat solution was then dip coated over the primer layer and oven dried at 100° C. for 30 minutes. The coated tubing was immersed in a Gentian Violet solution, Ricca Chemical, for 60 seconds after which the excess dye was rinsed off in cold tap water. The dyed samples were allowed to dry before adhesion testing.

Adhesion test results are summarized in Table 3.

TABLE 3

| | Adhesion Test | | | | |
|---|---|---|---|---|---|
| | Wet | Wet | Dry | | Tape |
| | Abrasion | Peel | Tape | Twist & Pull | Twist & Pull |
| Example 5 | Pass | Pass | Pass | Pass | Fail |
| Example 6 | Pass | Fail | Fail | Fail | Fail |
| Example 7 | Pass | Pass | Pass | Pass | Fail |

Good adhesion achieved without the epoxy resin in the pre-coat layer using a third type of organic titanate.

### Control Example 8

Silastic silicone tubing was cleaned by immersion in isopropanol and wiping of the outside of the tubing with isopropanol. The tubing was allowed to air dry at room temperature overnight. The silicone tubing was then oxygen plasma treated using 600 to 620 mTorr of oxygen pressure and 220 Rf watts of power. Within 4 hours the treated silicone tubing was coated with the following solution. A pre-coat solution composed of the following weight percents was made: 78.43% THF, 16.30% cyclohexanone, 4.007% poly (ethylene-co-acrylic acid) with 20 wt. % acrylic acid content, and 1.20% epoxy resin solution. The primer solution was dip coated onto the silastic tubing and allowed to air dry at room temperature for 2 hours. The pre-coat solution was then dip coated over the plasma treated primer layer and oven dried at 100° C. for 30 minutes. The coated tubing was immersed in a Gentian Violet solution, Ricca Chemical, for 60 seconds after which the excess dye was rinsed off in cold tap water. The dyed samples were allowed to dry before adhesion testing.

### Example 9

Silastic silicone tubing was cleaned by immersion in isopropanol and wiping of the outside of the tubing with isopropanol. The tubing was allowed to air dry at room temperature overnight. The silicone tubing was then oxygen plasma treated using 600 to 620 mTorr of oxygen pressure and 220 Rf watts of power. Within 4 hours the treated silicone was coated with the following two solutions. An organic titanate primer solution composed of the following wt. % was made: 5% TYZOR GBA a titanium acetylacetonate made by DuPont, 10% isopropanol and 85% THF. A pre-coat solution composed of the following weight percents was made: 78.43% THF, 16.30% cyclohexanone, 4.07% poly (ethylene-co-acrylic acid) with 20 wt. % acrylic acid content, and 1.20% epoxy resin solution. The primer solution was dip coated onto the silastic tubing and allowed to air dry at room temperature for 2 hours. The pre-coat solution was then dip coated over the primer layer and oven dried at 100° C. for 30 minutes. The coated tubing was immersed in a Gentian Violet solution, Ricca Chemical, for 60 seconds after which the excess dye was rinsed off in cold tap water. The dyed samples were allowed to dry before adhesion testing.

### Example 10

Silastic silicone tubing was cleaned by immersion in isopropanol and wiping of the outside of the tubing with isopropanol. The tubing was allowed to air dry at room temperature overnight. The silicone tubing was then oxygen plasma treated using 600 to 620 mTorr of oxygen pressure and 220 Rf watts of power. Within 4 hours the treated silicone was coated with the following two solutions. An organic titanate primer solution composed of the following wt. % was made: 5% TYZOR TnBT a tetra n-butyl titanate made by DuPont, 10% isopropanol and 85% THF. A pre-coat solution composed of the following weight percents was made: 78.43% THF, 16.30% cyclohexanone, 4.07% poly (ethylene-co-acrylic acid) with 20 wt % acrylic acid content, and 1.20% epoxy resin solution. The primer solution was dip coated onto the silastic tubing and allowed to air dry at room temperature for 2 hours. The pre-coat solution was then dip coated over the primer layer and oven dried at 100° C. for 30 minutes. The coated tubing was immersed in a Gentian Violet solution, Ricca Chemical, for 60 seconds after which the excess dye was rinsed off in cold tap water. The dyed samples were allowed to dry before adhesion testing.

### Example 11

Silastic silicone tubing was cleaned by immersion in isopropanol and wiping of the outside of the tubing with isopropanol. The tubing was allowed to air dry at room temperature overnight. The silicone tubing was then oxygen plasma treated using 600 to 620 mTorr of oxygen pressure and 220 Rf watts of power. Within 4 hours the treated silicone was coated with the following two solutions. An organic titanate primer solution composed of the following wt. % was made: 6.77% TYZOR BTP an n-butyl titanate polymer made by DuPont, 9.81% isopropanol and 83.15% THF. A pre-coat solution composed of the following weight percents was made: 78.43% THF, 16.30% cyclohexanone, 4.07% poly (ethylene-co-acrylic acid) with 20 wt. % acrylic acid content, and 1.20% epoxy resin solution. The primer solution was dip coated onto the silastic tubing and allowed to air dry at room temperature for 2 hours. The pre-coat solution was then dip coated over the primer layer and oven dried at 100° C. for 30 minutes. The coated tubing was immersed in a Gentian Violet solution, Ricca Chemical, for 60 seconds after which the excess dye was rinsed off in cold tap water. The dyed samples were allowed to dry before adhesion testing.

Adhesion test results are summarized in Table 4.

TABLE 4

| | Adhesion Test | | | | |
|---|---|---|---|---|---|
| | Wet | Wet | Dry | | Tape |
| | Abrasion | Peel | Tape | Twist & Pull | Twist & Pull |
| Example 8 | Pass | Fail | Fail | Fail | Fail |
| Example 9 | Pass | Pass | Pass | Pass | Pass |
| Example 2 | Pass | Pass | Pass | Pass | Fail |
| Example 10 | Pass | Pass | Pass | Pass | Pass |
| Example 11 | Pass | Pass | Pass | Pass | Pass |

Oxygen plasma treatment when used with the three different organic titanate primer layers (Examples 9-11) gave excellent results for bonding to silicone tubing in comparison to oxygen plasma treatment alone (Example 8). Comparing Example 2, which is the same as Example 9 but with no oxygen plasma pretreatment, shows further improvements in adhesion when both the organic titanate primer and oxygen plasma pretreatment are used in conjunction.

### Control Example 12

Silastic silicone tubing was cleaned by immersion in isopropanol and wiping of the outside of the tubing with isopropanol. The tubing was allowed to air dry at room temperature overnight. The silicone tubing was then plasma treated as described in the table below.

Treatment conditions are summarized in Table 5.

TABLE 5

| Gas | C₂F₆-1 | | C₂F₆-2 | | Ammonia -1 | | Ammonia -2 | | Oxygen | |
|---|---|---|---|---|---|---|---|---|---|---|
| Pressure | 560 | mTorr | 560 | mTorr | 400 | mTorr | 400 | mTorr | 560 | mTorr |
| Gas setting | 300 | skims | 300 | skims | 250 | skims | 250 | skims | 275 | skims |
| Power | 150 | W | 300 | W | 150 | W | 300 | W | 150 | W |
| Time | 2 | minutes | 2 | minutes | 2 | minutes | 2 | minutes | 2 | minutes |

The treated silicone tubing was coated with the following solutions. A pre-coat solution composed of the following weight percents was made: 78.43% THF, 16.30% cyclohexanone, 4.07% poly (ethylene-co-acrylic acid) with 20 wt. % acrylic acid content, and 1.20% epoxy resin solution. A base-coat solution composed of the following weight percents was made: 7.5% toluene, 7.7% benzyl alcohol, 56.49% THF, 10% cyclohexanone, 3% dibutylphthalate, 2.03% Cymel 248-8 a melamine-formaldehyde resin made by American Cyanamid, 0.88% butanol, 0.6% xylene, 6.9% nitrocellulose, 4.87% aliphatic polyether-based polyurethane, 0.03% trichloroacetic acid. A top-coat solution composed of the following weight percents was made: 37.49% ethanol, 34.48% benzyl alcohol, 17.4% isopropanol, 2.7% cyclohexanone, 5.8% polyvinylpyrrolidone K90 made by ISP Technologies, 0.0009% nitrocellulose, 0.0091% 4-butyrolactone, and 1.8% polyethylene glycol average (Mₙ=400).

Within 6 hours the pre-coat solution was dip coated over the plasma treated silicone tubing and oven dried at 100° C. for 30 minutes. The base-coat layer was coated next and dried at 100° C. for 30 minutes. The top-coat layer (described below) was coated last and dried at 90° C. for 45 minutes. The coated tubing was immersed in a Gentian Violet solution, Ricca Chemical, for 60 seconds after which the excess dye was rinsed off in cold tap water. The dyed samples were allowed to dry before adhesion testing.

### Example 13

The silicone tubing was cleaned and plasma treated the same as in Example 12. A primer solution composed of the following weight percents was made: 5% TYZOR TnBT a tetra n-butyl titanate made by DuPont, 10% isopropanol and 85% THF. Within 4 hours the plasma treated tubing was dip coated with the primer solution and allowed to air dry for one hour. After the organic titanate primer coating, the silicone tubing received the same series of coatings as in Example 12.

### Example 14

The silicone tubing was cleaned and plasma treated the same as in Example 12. A primer solution composed of the following weight percents was made: 5% TYZOR GBA titanium acetylacetonate made by DuPont, 10% isopropanol and 85% THF. Within 4 hours the plasma treated tubing was dip coated with the primer solution and allowed to air dry for one hour. A base-coat solution with the following wt % composition was made: 23.3% aromatic polyurethane, 17.47% anisole, and 59.23% methyl isobutyl ketone (MIBK). The base-coat solution was coated over the primer layer within 6 hours of plasma treatment. The coated tubing was and oven dried at 100° C. for 30 minutes. A biopolymer coating solution with no drug and the following wt % composition was made: 12.62% aromatic polyurethane, 27.32% anisole, 8.83% N,N dimethyl acetamide, 29.66% methyl ethyl ketone, 19.73% N-butyl alcohol, 1.84% nitrocellulose. The biopolymer coating solution was coated over the base-coat layer and was dried at 75° C. for 45 minutes. The coated tubing was immersed in a Gentian Violet solution, Ricca Chemical, for 60 seconds after which the excess dye was rinsed off in cold tap water. The dyed samples were allowed to dry before adhesion testing.

Dry tape adhesion test results for the different plasma treated samples of silicone tubing are summarized in Table 6.

TABLE 6

| Plasma Gas | C₂F₆-1 | C₂F₆-2 | Ammonia 1 | Ammonia 2 | Oxygen | No Plasma |
|---|---|---|---|---|---|---|
| Example 12 | Fail | Fail | Fail | Fail | Fail | Fail |
| Example 13 | Fail | Fail | Pass | Fail | Pass | Pass |
| Example 14 | Fail | Fail | Pass | Pass | Pass | Fail |

None of the plasma treatments by themselves passed the dry tape adhesion test. Ammonia and oxygen plasma treatments enhanced adhesion of adhesion promoter layers.

### Control Example 15

Stainless steel coupons (SS-316) were cleaned by sonication using a cleaning solution composed of 50% THF and 50% N,N dimethyl acetamide. A pre-coat solution composed of a polymer blend of vinyl acetate acrylic copolymer and a formaldehyde copolymer was coated onto the cleaned SS-316 coupon and dried at 100° C. for 30 minutes. The coated coupon was immersed in a Gentian Violet solution, Ricca Chemical, for 60 seconds after which the excess dye was rinsed off in cold tap water. The dyed samples were allowed to dry before adhesion testing.

### Control Example 16

Stainless steel coupons (SS-316) were cleaned by sonication using a cleaning solution composed of 50% THF and 50% N,N dimethyl acetamide. A pre-coat solution composed of a polymer blend of vinyl acetate acrylic copolymer and a formaldehyde copolymer was coated on the coupon and dried at 100° C. for 30 minutes. A base-coat composed of 7.5% toluene, 7.7% benzyl alcohol, 56.49% THF, 10% cyclohexanone, 3% dibutylphthlate, 2.03% a melamine-formaldehyde resin, 0.88% butanol, 0.6% xylene, 6.9% nitrocellulose, 4.87% aliphatic polyether-based polyurethane, 0.3% trichloroacetic acid was coated over the pre-coat layer and dried at 100° C. for 30 minutes. The coated coupon was immersed in a Gentian Violet solution, Ricca Chemical, for 60 seconds after which the excess dye was rinsed off in cold tap water. The dyed samples were allowed to dry before adhesion testing.

### Example 17

The SS-316 coupon was cleaned and coated as in Example 16 except an organic titanate layer was coated on the coupon before the pre-coat layer and allowed to dry at room temperature for 2 hours.

### Example 18

The SS-316 coupon was cleaned and coated as in Example 17 except a non drug containing biopolymer coating with a composition of 13.76% aromatic polyurethane, 26.5% anisole, 7.4% N,N dimethyl acetamide, 28.75% methyl ethyl ketone, 19.17% N-butyl alcohol, and 4.22% nitrocellulose was coated over the base-coat and dried at 75° C. for 45 minutes. The coated tubing was immersed in a Gentian Violet solution, Ricca Chemical, for 60 seconds after which the excess dye was rinsed off in cold tap water. The dyed samples were allowed to dry before adhesion testing.

Adhesion test results are summarized in Table 7A.

TABLE 7A

| | Adhesion Test | | | | |
|---|---|---|---|---|---|
| | Wet | Wet | Dry | | Tape |
| | Abrasion | Peel | Tape | Twist & Pull | Twist & Pull |
| Example 15 | Pass | Pass | Pass | NA | NA |
| Example 16 | Pass | Fail | Fail | NA | NA |
| Example 17 | Pass | Pass | Pass | NA | NA |
| Example 18 | Pass | Pass | Pass | NA | NA |

The rubber to metal adhesives gave good results when a single layer, Example 15, was coated onto the coupons. Once a base-coat layer was added, Example 16, the adhesion performance suffered. Example 17 shows that the addition of an adhesion promoter, such as an organic titanate primer layer, restored good adhesion under the dry tape test when the base-coat layer was added. In Example 18, good adhesion was maintained when both a base-coat and a biopolymer coating were added when an organic titanate was used in a primer layer.

### Example 19

Silastic silicone tubing was cleaned by immersion in isopropanol and wiping of the outside of the tubing with isopropanol. The tubing was allowed to air dry at room temperature overnight. The silicone tubing was then oxygen plasma treated using 600 to 620 mTorr of oxygen pressure and 220 Rf watts of power. Within 4 hours the treated silicone was coated with the following two solutions. An organic titanate primer solution composed of the following wt. % was made: 5% TYZOR OGT an octyleneglycol titanate made by DuPont, 10.0% isopropanol and 85.0% THF. A pre-coat solution composed of the following weight percents was made: 78.43% THF, 16.30% cyclohexanone, 4.07% poly (ethylene-co-acrylic acid) with 20 wt. % acrylic acid content, and 1.20% epoxy resin solution. The primer solution was dip coated onto the silastic tubing and allowed to air dry at room temperature for 2 hours. The pre-coat solution was then dip coated over the primer layer and oven dried at 100° C. for 30 minutes. A base-coat solution composed of 15.84% aromatic polyurethane, 11.88% anisole, 40.28% methyl isobutyl ketone (MIBK), and 32.0% THF was coated over the primer layer within 24 hours of plasma treatment and oven dried at 100° C. for 30 minutes. A biopolymer coating with no drugs present and composed of 15.89% aromatic polyurethane, 22.36% anisole, 2.93% N,N dimethyl acetamide, 24.26% methyl ethyl ketone, 16.17% N-butyl alcohol, 16.07% THF, and 2.32% nitrocellulose was coated over the base-coat layer and dried at 75° C. for 45 minutes. The coated tubing was immersed in a Gentian Violet solution, Ricca Chemical, for 60 seconds after which the excess dye was rinsed off in cold tap water. The dyed samples were allowed to dry before adhesion testing. Ten samples were coated as above and the adhesion results are summarized the table below.

Adhesion test results are summarized in Table 7B.

TABLE 7B

| | Adhesion Test | | | | |
|---|---|---|---|---|---|
| | Wet | Wet | Dry | | Tape |
| | Abrasion | Peel | Tape | Twist & Pull | Twist & Pull |
| Example 19-1 | Pass | Pass | Pass | Pass | Pass |
| Example 19-2 | Pass | Pass | Pass | Pass | Pass |
| Example 19-3 | Pass | Pass | Pass | Pass | Pass |
| Example 19-4 | Pass | Pass | Pass | Pass | Pass |
| Example 19-5 | Pass | Pass | Fail | Pass | Fail |
| Example 19-6 | Pass | Pass | Pass | Pass | Pass |
| Example 19-7 | Pass | Pass | Pass | Pass | Pass |
| Example 19-8 | Pass | Pass | Pass | Pass | Pass |
| Example 19-9 | Pass | Pass | Pass | Pass | Pass |
| Example 19-10 | Pass | Pass | Pass | Pass | Pass |

### Example 20

Silastic silicone tubing was cleaned by immersion in isopropanol and wiping of the outside of the tubing with isopropanol. The tubing was allowed to air dry at room temperature overnight. The silicone tubing was then oxygen plasma treated using 600 to 620 mTorr of oxygen pressure and 220 Rf watts of power. Within 4 hours the treated silicone was coated with the following two solutions. An organic titanate primer solution composed of the following wt. % was made: 5% TYZOR OGT an octyleneglycol titanate made by DuPont, 10.0% isopropanol and 85.0% THF. A pre-coat solution composed of the following weight percents was made: 78.43% THF, 16.30% cyclohexanone, 4.07% poly (ethylene-co-acrylic acid) with 20 wt. % acrylic acid content, and 1.20% epoxy resin solution. The primer solution was dip coated onto the silastic tubing and allowed to air dry at room temperature for 2 hours. The pre-coat solution was then dip coated over the primer layer and oven dried at 100° C. for 30 minutes. A base-coat solution composed of 15.84% aromatic polyurethane, 11.88% anisole, 40.28% methyl isobutyl ketone (MIBK), and 32.0% THF was coated over the pre-coat layer within 24 hours of plasma treatment and oven dried at 100° C. for 30 minutes. A biopolymer coating composed of 0.62% paclitaxel, 15.79% aromatic polyurethane, 22.22% anisole, 2.91% N,N dimethyl acetamide, 24.11% methyl ethyl ketone, 16.07% N-butyl alcohol, 15.97% THF, and 2.30% nitrocellulose was coated over the base-coat layer and dried at 75° C. for 45 minutes. The coated tubing was immersed in a Gentian Violet solution, Ricca Chemical, for 60 seconds after which the excess dye was rinsed off in cold tap water. The dyed samples were allowed to dry before adhesion testing. Ten samples were coated as above and the adhesion results are summarized the table below.

Adhesion test results are summarized in Table 8.

TABLE 8

| | Adhesion Test | | | | |
|---|---|---|---|---|---|
| | Wet | Wet | Dry | | Tape |
| | Abrasion | Peel | Tape | Twist & Pull | Twist & Pull |
| Example 20-1 | Pass | Pass | Pass | Pass | Pass |
| Example 20-2 | Pass | Pass | Pass | Pass | Pass |
| Example 20-3 | Pass | Pass | Pass | Pass | Pass |
| Example 20-4 | Pass | Pass | Fail | Pass | Pass |
| Example 20-5 | Pass | Pass | Pass | Pass | Fail |
| Example 20-6 | Pass | Pass | Pass | Pass | Pass |
| Example 20-7 | Pass | Pass | Pass | Pass | Pass |
| Example 20-8 | Pass | Pass | Pass | Pass | Pass |
| Example 20-9 | Pass | Pass | Pass | Pass | Pass |
| Example 20-10 | Pass | Pass | Pass | Pass | Pass |

### Example 21

Silastic silicone tubing was cleaned by immersion in isopropanol and wiping of the outside of the tubing with isopropanol. The tubing was allowed to air dry at room temperature overnight. The silicone tubing was then oxygen plasma treated using 600 to 620 mTorr of oxygen pressure and 220 Rf watts of power. Within 4 hours the treated silicone was coated with the following two solutions. An organic titanate primer solution composed of the following wt. % was made: 5% TYZOR OGT an octyleneglycol titanate made by DuPont, 10.0% isopropanol and 85.0% THF. A pre-coat solution composed of the following weight percents was made: 78.43% THF, 16.30% cyclohexanone, 4.07% poly (ethylene-co-acrylic acid) with 20 wt. % acrylic acid content, and 1.20% epoxy resin solution. The primer solution was dip coated onto the silastic tubing and allowed to air dry at room temperature for 2 hours. The pre-coat solution was then dip coated over the primer layer and oven dried at 100° C. for 30 minutes. A base-coat solution composed of 15.84% aromatic polyurethane, 11.88% anisole, 40.28% methyl isobutyl ketone (MIBK), and 32.0% THF was coated over the pre-coat layer within 24 hours of plasma treatment and oven dried at 100° C. for 30 minutes. A biopolymer coating solution composed of 1.58% paclitaxel, 18.63% aromatic polyurethane, 26.22% anisole, 3.43% N,N dimethyl acetamide, 28.45% methyl ethyl ketone, 18.96% N-butyl alcohol, 2.72% nitrocellulose was coated over the base-coat layer and dried at 75° C. for 45 minutes. The coated tubing was immersed in a Gentian Violet solution, Ricca Chemical, for 60 seconds after which the excess dye was rinsed off in cold tap water. The dyed samples were allowed to dry before adhesion testing. Ten samples were coated as above and the adhesion results are summarized the table below.

Adhesion test results are summarized in Table 9.

TABLE 9

| | Adhesion Test | | | | |
|---|---|---|---|---|---|
| | Wet | Wet | Dry | | Tape |
| | Abrasion | Peel | Tape | Twist & Pull | Twist & Pull |
| Example 21-1 | Pass | Pass | Pass | Pass | Pass |
| Example 21-2 | Pass | Pass | Pass | Pass | Pass |
| Example 21-3 | Pass | Pass | Pass | Pass | Pass |
| Example 21-4 | Pass | Pass | Pass | Pass | Pass |
| Example 21-5 | Pass | Pass | Pass | Pass | Pass |
| Example 21-6 | Pass | Pass | Fail | Pass | Pass |
| Example 21-7 | Pass | Pass | Pass | Pass | Pass |
| Example 21-8 | Pass | Pass | Pass | Pass | Pass |
| Example 21-9 | Pass | Pass | Fail | Pass | Pass |
| Example 21-10 | Pass | Pass | Pass | Pass | Pass |

In another set of examples, adhesion promoters were tested for cytotoxicity using L929 mammalian fibroblast cells grown and maintained in Minimum Essential Medium (MEM) with Earle's Balanced Salts. The MEM Elution Tissue Culture Test is an in vitro procedure designed to determine the biological reactivity of mammalian cell cultures following incubation with extracts of test articles. This procedure allows for extraction of test articles at physiological or non-physiological temperatures for varying time intervals. The test is used at the initial stages of material development to determine the toxicity as well as potential biological responses in vivo. Methods used were identical to ISO 10993-5:1999.

### Example 22

Uncoated silicone tubing was used to test toxicity of the silicone. The silicone tubing was cleaned by immersion in isopropanol and wiping of the outside of the tubing with isopropanol. The tubing was allowed to air dry at room temperature overnight.

### Example 23

Sterile latex rubber (SAFESKIN^{R}) was used as a positive control.

### Example 24

USP high-density polyethylene reference standard was used as a negative control.

### Example 25

Silastic silicone tubing was cleaned by immersion in isopropanol and wiping of the outside of the tubing with isopropanol. The tubing was allowed to air dry at room temperature overnight. An organic titanate primer solution composed of the following wt. % was made: 5% TYZOR OGT an octyleneglycol titanate made by DuPont, 10.0% isopropanol and 85.0% THF. The primer solution was dip coated onto the silastic tubing and allowed to air dry at room temperature for 2 hours.

### Example 26

Silastic silicone tubing was cleaned by immersion in isopropyl isopropanol and wiping of the outside of the tubing with isopropanol. The tubing was allowed to air dry at room temperature overnight. An organic titanate primer solution composed of the following wt. % was made: 5% TYZOR OGT an octyleneglycol titanate made by DuPont, 10.0% isopropanol and 85.0% THF. A pre-coat solution composed of the following weight percents was made. 78.43% THF, 16.30% cyclohexanone, 4.07% poly (ethylene-co-acrylic acid) with 20 wt. % acrylic acid content, and 1.20% epoxy resin solution. The primer solution was dip coated onto the silastic tubing and allowed to air dry at room temperature for 2 hours. The pre-coat solution was then dip coated over the primer layer and oven dried at 100° C. for 30 minutes.

### Example 27

Silastic silicone tubing was cleaned by immersion in isopropanol and wiping of the outside of the tubing with isopropanol. The tubing was allowed to air dry at room temperature overnight. An organic titanate primer solution composed of the following wt. % was made: 5% TYZOR OGT an octyleneglycol titanate made by DuPont, 10.0% isopropanol and 85.0% THF. A pre-coat solution composed of the following weight percents was made. 78.43% THF, 16.30% cyclohexanone, 4.07% poly (ethylene-co-acrylic acid) with 20 wt. % acrylic acid content, and 1.20% epoxy resin solution. The primer solution was dip coated onto the silastic tubing and allowed to air dry at room temperature for 2 hours. The pre-coated solution was then dip coated over the primer layer and oven dried at 100° C. for 30 minutes. A base-coat solution was made with the following wt % composition: 23.3% aromatic polyurethane, 17.47% anisole, and 59.23% methyl isobutyl ketone (MIBK). The base-coat solution was dip coated over the pre-coat layer and oven dried at 100° C. for 30 minutes.

### Example 28

Silastic silicone tubing was cleaned by immersion in isopropanol and wiping of the outside of the tubing with isopropanol. The tubing was allowed to air dry at room temperature overnight. An organic titanate primer solution composed of the following wt. % was made: 5% TYZOR OGT an octyleneglycol titanate made by DuPont, 10.0% isopropanol and 85.0% THF. A pre-coat solution composed of the following weight percents was made. 78.43% THF, 16.30% cyclohexanone, 4.07% poly (ethylene-co-acrylic acid) with 20 wt. % acrylic acid content, and 1.20% epoxy resin solution. The primer solution was dip coated onto the silastic tubing and allowed to air dry at room temperature for 2 hours. The pre-coat solution was then dip coated over the primer layer and oven dried at 100° C. for 30 minutes. A base-coat solution was made with the following wt % composition: 23.3% aromatic polyurethane, 17.47% anisole, and 59.23% methyl isobutyl ketone (MIBK). The base-coated solution was dip coated over the pre-coat layer and oven dried at 100° C. for 30 minutes. A non-drug containing biopolymer coating composed of 13.76% aromatic polyurethane, 26.5% anisole, 7.4% N,N dimethyl acetamide, 28.75% methyl ethyl ketone, 19.17% N-butyl alcohol, and 4.22% nitrocellulose was coated over the base-coat layer and dried at 75° C. for 45 minutes.

One set of samples, n=3, was extracted in serum supplemented MEM for 24 hours at 37° C. A second set of samples, n=3, was extracted in USP Saline for 24 hours at 70° C. The grading system used to evaluate the effects of the extracted samples on the L929 cell plates is summarized in Table 10.

TABLE 10

| Grade | Reactivity | Conditions of Cell Cultures |
|---|---|---|
| 0 | None | Discrete intracytoplasmic granules; no cell lysis |
| 1 | Slight | Not more than 20% of the cells are round, loosely |
| | | attached, and without intracytoplasmic granules; |
| | | occasionally lysed cells are present. |
| 2 | Mild | Not more than 50% of the cells are round and |
| | | devoid of intracytoplasmic granules; no extensive |
| | | cell lysis and empty areas between cells. |
| 3 | Moderate | Not more than 70% of the cell layers contain |
| | | rounded cells or are lysed. |
| 4 | Severe | Nearly complete destruction of the cell layers. |

Test results are summarized in Table 11.

TABLE 11

| Test Sample | Extraction Medium | Grade | Reactivity |
|---|---|---|---|
| Example 22 | MEM | 0, 0, 0 | None |
| Example 22 | Saline | 0, 0, 0 | None |
| Example 23 | MEM | 4, 4, 4 | Severe |
| Example 23 | Saline | 4, 4, 4 | Severe |
| Example 24 | MEM | 0, 0, 0 | None |
| Example 24 | Saline | 0, 0, 0 | None |
| Example 25 | MEM | 0, 0, 0 | None |
| Example 25 | Saline | 0, 0, 0 | None |
| Example 26 | MEM | 0, 0, 0 | None |
| Example 26 | Saline | 0, 0, 0 | None |
| Example 27 | MEM | 0, 0, 0 | None |
| Example 27 | Saline | 0, 0, 0 | None |
| Example 28 | MEM | 0, 0, 0 | None |
| Example 28 | Saline | 0, 0, 0 | None |

None of the test samples that contained the adhesion promoter induced cytotoxicity under either of extraction conditions employed.

Other embodiments are within the scope of the following claims.

1. A process for producing a medical device, comprising:
applying an adhesion promoting composition to a portion of a surface of a medical device, wherein the surface of the device comprises a plurality of surface functional groups, and the adhesion promoting composition comprises an adhesion promoter, the adhesion promoter including a promoter functional group capable of reacting with the surface functional groups, the adhesion promoting composition being applied under conditions selected to cause reaction between the promoter functional groups and the surface functional groups, and wherein the adhesion promoter retains a plurality of unreacted promoter functional groups after reaction with the surface functional groups;
applying a polymer composition to a portion of the surface of the device, the polymer composition comprising a plurality of polymer functional groups capable of reacting with promoter functional groups, the polymer composition being applied under conditions selected to cause reaction between the promoter functional groups and the polymer functional groups; and
applying a biopolymer composition to a portion of the surface of the device, wherein the biopolymer composition comprises a therapeutic or diagnostic agent.

2. The process of claim 1, wherein reaction between the promoter functional groups and the surface functional groups forms a plurality of covalent bonds between the adhesion promoter and the surface of the device.

3. The process of claim 1, wherein reaction between the promoter functional groups and the polymer functional groups forms a plurality of covalent bonds between the adhesion promoter and the polymer composition.

4. The process of claim 1, further comprising treating the surface of the device with an ionizing treatment.

5. (canceled)

6. The process of claim 1, wherein the device includes a polymer substrate.

7. The process of claim 6, wherein the polymer substrate is a silicone, a polyimide, a PTFE, a polyethylene, or a polyester.

8. The process of claim 1, wherein the device includes a metal substrate.

9. The process of claim 8, wherein the metal substrate is titanium, stainless steel, nickel, gold, chrome, tantalum, nitinol, platinum, silver, cobalt, an alloy including titanium, an alloy including stainless steel, an alloy including nickel, an alloy including gold, an alloy including chrome, an alloy including tantalum, an alloy including platinum, an alloy including silver, or an alloy including cobalt.

10. The process of claim 1, wherein the adhesion promoter includes an organic titanate.

11-12. (canceled)

13. The process of claim 1, wherein the biopolymer composition includes a lubricious component.

14-19. (canceled)

20. A process for producing a medical device, comprising:
applying an adhesion promoting composition to a portion of a surface of a medical device, wherein the surface of the device comprises a plurality of surface functional groups, and the adhesion promoting composition comprises an adhesion promoter, the adhesion promoter including a promoter functional group capable of reacting with the surface functional groups, the adhesion promoting composition being applied under conditions selected to cause reaction between the promoter functional groups and the surface functional groups, and wherein the adhesion promoter retains a plurality of unreacted promoter functional groups after reaction with the surface functional groups; and
applying a biopolymer composition to a portion of the surface of the device, wherein the biopolymer composition comprises a therapeutic or diagnostic agent.

21. The process of claim 20, wherein reaction between the promoter functional groups and the surface functional groups forms a plurality of covalent bonds between the adhesion promoter and the surface of the device.

22. The process of claim 20, wherein reaction between the promoter functional groups and the polymer functional groups forms a plurality of covalent bonds between the adhesion promoter and the biopolymer composition.

23. The process of claim 20, further comprising treating the surface of the device with an ionizing treatment.

24-26. (canceled)

27. The process of claim 20, wherein the device includes a metal substrate.

28. The process of claim 27, wherein the metal substrate is titanium, stainless steel, nickel, gold, chrome, tantalum, nitinol, platinum, silver, cobalt, an alloy including titanium, an alloy including stainless steel, an alloy including nickel, an alloy including gold, an alloy including chrome, an alloy including tantalum, an alloy including platinum, an alloy including silver, or an alloy including cobalt.

29. The process of claim 20, wherein the adhesion promoter includes an organic titanate.

30-31. (canceled)

32. The process of claim 20, wherein the biopolymer composition includes a lubricious component.

33-39. (canceled)

40. A medical device comprising a coating on a portion of a surface the device, wherein the coating comprises a polymer composition and a linking group forming a covalent bond between the surface of the device and a component of the polymer composition, wherein the covalent bond includes a metal ether linkage.

41. The medical device of claim 40, wherein the metal ether linkage is a titanium ether linkage.

42-43. (canceled)

44. The medical device of claim 40, wherein the polymer composition includes a biopolymer composition.

45-52. (canceled)
